(19) United States
(12) Patent Application Publication
(10) Pub. No.: US 2025/0238702 A1
(43) Pub. Date: Jul. 24, 2025

(54) EXPLAINABLE QUANTUM ANNEALING

(71) Applicant: Dell Products L.P., Round Rock, TX (US)

(72) Inventors: Brendan Burns Healy, Haddonfield, NJ (US); Mahi Ismail, New Cairo (EG); Yasmin Mansy, Cairo (EG)

(21) Appl. No.: 18/420,658

(22) Filed: Jan. 23, 2024

(51) Int. Cl. G06N 10/60; G06F 9/50

(52) U.S. Cl. CPC G06N 10/60; G06F 9/5038

(57) ABSTRACT

One example method includes providing a problem, and associated inputs and constraints, to an annealer, when the annealer runs an annealing process on the problem and does not find a solution to the problem that meets the constraints, loosening one of the constraints, re-running the annealing process using the constraint that was loosened, performing the loosening, and the re-running, until a new and feasible solution is found that meets the constraints, and performing an optimization process that comprises re-running the annealing process, with noise, to determine whether a solution exists that is better than the new and feasible solution.

### FIELD OF THE INVENTION

Embodiments of the present invention generally relate to annealing processes. More particularly, at least some embodiments of the invention relate to systems, hardware, software, computer-readable media, and methods, for adding context in the form of metadata to a job file to enable a workflow that executes the job to adjust the execution of the job to suit the context.

### BACKGROUND

Given both the novelty and complexity of quantum annealing technology, the solutions generated by annealers are often difficult to interpret and justify. This, in turn, reduces the amount of trust and reliability in the technology despite its powerful optimization capabilities.

In more detail, a current approach to the use of annealing to solve problems such as QUBOs (quadratic unconstrained binary optimization), involves using an annealer to take an underlying optimization problem, previously converted by another entity into a mathematical QUBO formulation, that is, a quadratic multivariate polynomial which has a preset list of global minima which the annealer is searching for, and then submitting this mathematical object to the annealer to return the lowest value of the polynomial that it can find.

Once the QUBO is formed, there is no way to change it without beginning the process over again, manually. That is, the underlying problem, after being modified, must be reformulated into a new QUBO which can then be submitted to the annealer for solution. However, the annealer, and any classical computing hardware attached to it, does not have the capability to take in additional information, such as constraints, metadata, and units for example, concerning the underlying problem. Moreover, the annealer lacks the capability to act on such information in any event, and is only able look for underlying minima. In fact, the annealer is unable to distinguish the objective function from a constraint, since the constraints are merely appended to the polynomial as weighted penalties.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1a discloses aspects of an example architecture according to one embodiment.

FIG. 1b discloses aspects of an example method according to one embodiment.

FIG. 2 discloses an example of a problem that may solved, and the solution explained, according to one embodiment.

FIG. 3 discloses a code snippet for incrementing/decrementing of parameters, according to one embodiment.

FIG. 4 discloses a code snippet for the implementation of explainable constraints, according to one embodiment.

FIG. 5 discloses a code snippet for indicating, by an annealer, an extent to which a constraint is broken, according to one embodiment.

FIG. 6 discloses a code snippet for performing a test to determine whether a parameter should be increased or decreased, according to one embodiment.

FIG. 7 discloses an approach for the use of an expanded solution space, according to one embodiment.

FIG. 8 discloses a code snippet for creating an objection function, according to one embodiment.

FIG. 9 discloses aspects of an example embodiment of a computing entity, which may comprise classical and/or quantum components, including annealers, configured and operable to perform part, or all, of any of the disclosed methods, processes, and operations.

### DETAILED DESCRIPTION OF SOME EXAMPLE EMBODIMENTS

Embodiments of the present invention generally relate to annealing processes. More particularly, at least some embodiments of the invention relate to systems, hardware, software, computer-readable media, and methods, for adding context in the form of metadata to a job file to enable a workflow that executes the job to adjust the execution of the job to suit the context.

One example embodiment of the invention is directed to a method that may comprise the following operations: for a given problem, such as a QUBO (quadratic unconstrained binary optimization) problem, inputting the QUBO and metadata, which may be in the form of problem constraints and parameters, to an annealer; running an annealer and performing a check to determine if a feasible solution has been found, that is, a solution that meets the specified constraints; when no feasible solution is found, finding, by an explainer, the most restrictive constraints and then iteratively loosening the constraints and expanding associated parameters and returning the modified constraints and parameters to the annealer until a feasible solution is found; after a feasible solution is found, performing a check to determine if the solution has been presented previously; if the solution has not been presented previously, re-running the annealing process, with noise, and outputting a solution, and, if a user is satisfied with the solution, the explainable optimization of the problem solution is completed; if the solution has been presented previously, re-running the annealing process until a new solution is found that meets the constraints—then, performing a check to determine if a new solution has been found and, if so, returning the process for re-running the annealing process with noise, and if a new solution is not found, prompting the user to introduce a new constraint and re-run the explainer—at this point, the explainable optimization for the initially defined problem and constraints May be considered as complete.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at one embodiment is that a solution generated by an annealer may be explained, and the explanation presented to a user. One embodiment may embed real-world context, possibly in the form of metadata, into an annealing job that provides a human-understandable explanation of the results, or solution, generated by the annealing job. One embodiment may implement an overarching workflow, that is, overarching an annealing process, to algorithmically adjust, on the fly, execution of the annealing process according to metadata that was provided to the annealer along with the problem to be solved. Various other advantages of one or more example embodiments will be apparent from this disclosure.

### A. Aspects of an Example Architecture

The following is a discussion of aspects of an example architecture for various embodiments of the invention. This discussion is not intended to limit the scope of the invention, or the applicability of the embodiments, in any way.

In general, embodiments of the invention may be implemented in connection with quantum computing systems and components, and/or with classical computing systems and components. By way of example, one embodiment may employ an annealer which may comprise, or consist of, classical computing components such as memory and processors for example. One embodiment may employ an annealer that comprises, or consists, of a quantum annealer. An annealer according to one embodiment may be a digital annealer, or a simulated annealer. No particular type or configuration of annealer is required in any embodiment however. In one embodiment, an explainer may comprise, or consist of, classical computing components.

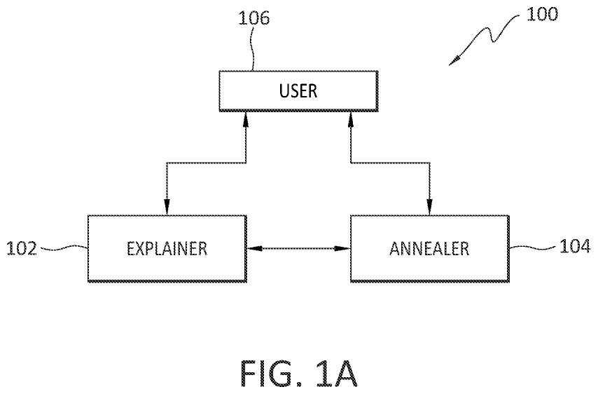

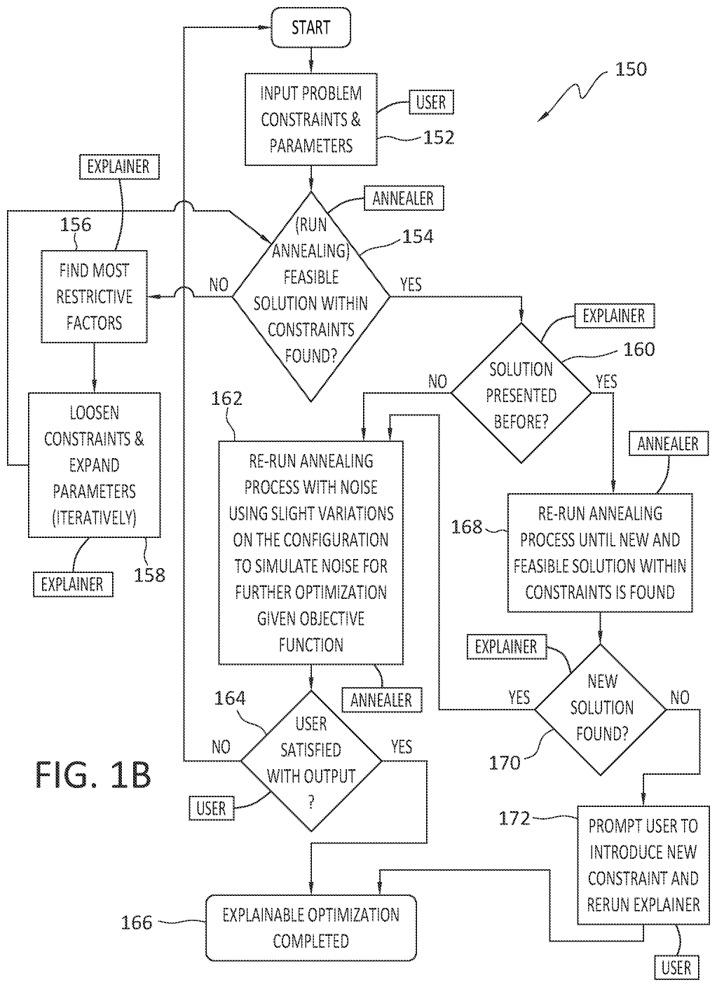

With reference briefly now to FIG. 1a, an example architecture 100 according to one embodiment is disclosed. As shown there, the architecture 100 may comprise an explainer 102, and an annealer 104, both of which are configured to communicate with each other. A user 106, which may be a human in one embodiment, may communicate with both the explainer 102 and the annealer 104, as explained in further detail in the discussion, below, of FIG. 1b.

### B. Overview of Aspects of an Example Embodiment

One example embodiment adopts some principles from the practice of explainable artificial intelligence (XAI) for the purposes of quantum annealing. The XAI movement is motivated by the fact that AI algorithms are often completely opaque to the user, and little output besides the “final answer” is provided by the device. To rectify this, XAI practices act iteratively, following algorithmic decision making that is eventually made available to the user.

More specifically, one embodiment comprises a procedure, or method, for embedding real-world context into quantum annealing jobs that enables more human-readable results. A discussion is also provided of a detailed example implementation. In more detail, one embodiment comprises the application of general techniques, used in explainable AI, to jobs submitted to annealers, which may be, for example, quantum, digital, or simulated using classical hardware. This approach comprises the inclusion of metadata to the job file, such as a QUBO, that enables an overarching workflow to algorithmically adjust execution of the annealing job. The metadata added acts as a conduit for the injection of real-world context into the problem, which can be manipulated as additional information beyond the purely mathematical problem statement that is the QUBO.

### C. Detailed Discussion of Aspects of an Example Embodiment

Generally, one example embodiment may comprise various features and aspects. For example, an embodiment may provide for the injection of real-world context into the QUBO problem format to enable explainable results. That is, a mechanism may be provided by which metadata can be attached to the submitted QUBO problem, also referred to herein simply as a ‘problem,’ where that metadata represents some form of physical reality of the problem. The workload then becomes a hybrid that includes the purely mathematical QUBO combined with extra data and/or metadata which may replace any nuance that was stripped back by the formalism required to define and submit the job to the annealer.

As another example, one embodiment may implement manipulation of a problem context, which may take the form of problem metadata, in order to provide more robust outcomes and automate “human-in-the-loop” steps of a quantum annealing workflow. In particular, one embodiment comprises a process which reads in metadata, examples of which are disclosed herein, and uses that metadata to make real time decisions regarding the QUBO solution workflow being performed by the annealer, that is, the execution and modification of the annealing job. In this way, an embodiment may operate to change the QUBO itself in order to provide value and, as such, an embodiment may comprise the use of metadata that includes a feedback mechanism to influence the purely mathematical quantum job, that is, the QUBO.

The way that such metadata is organized, read, and manipulated may be seen as a version of human-in-the-loop problem solving, except that the actions of the “human” are automated and are pre-determined according to some logic or flowchart. FIG. 1b, discussed below, discloses an example workflow 150 that comprises a QUBO solution process, guided by metadata.

### C.1 Overview of Aspects of an Example Embodiment

One method for compiling QUBO problems into the format required for quantum annealing is ‘PyQUBO,’ a Python-based approach for QUBO compilation. One feature of a PyQUBO module is that it enables a user to tag parameters and constraints with strings. This feature may make it convenient to recall these constraints and parameters, after the results are found, to see their values/truth values respectively. Note that this may be necessary because non-binary, that is, integer or float, parameters may have to be converted into a collection of binary variables, as an annealer can natively operate only using binaries. Thus, the value of a more complex valued parameter must be post-hoc determined from the “spins,” that is, the bit array of 0s and 1s representing the output of the annealer. The string is thus used as a sort of unique ID for the purpose of post-processing data.

In an embodiment however, this string can be employed to greater effect. At the time of variable initialization, an embodiment may inject tags into these strings to not only parse individual variables, but also classes of variables which represent similar portions of the underlying problem. Now, when checking constraints and postprocessing, an embodiment may separate out parameters according to their type, unit (such as dollars, degrees Fahrenheit, for example), relative importance, or any other factors chosen for consideration, and then tag those parameters. A discussion of one example of this type of implementation is included below.

Additionally, an embodiment that may used metadata to guide an annealing process may differ from conventional explainable AI, in a variety of respects. For example, what an embodiment of xQA (explainable quantum annealing) is capable of, that XAI is not, is a specific part of how annealing processing works on optimization problems. Particularly, an annealer has the ability, through its statistical nature and the “unconstrained” part of QUBO, to determine properties of the problem landscape that other processing approaches do not. If fed an unfeasible problem, that is, an optimization problem which is over-constrained, and no parameter values satisfy all constraints at once, the annealer will return a “least out of bound” solution, rather than no solution whatsoever (as disclosed in U.S. patent application Ser. No. 18/169,050, entitled USE OF ANNEALING PROCESSORS TO IDENTIFY LIMITING CONSTRAINTS IN OPTIMIZATION, filed 14 Feb. 23, and incorporated herein in its entirety by this reference). An embodiment may leverage this capability to play off different classes of constraints against each other, such as by changing their respective associated weights.

### C.2 Aspects of an Example Method

With reference now to FIG. 1b through FIG. 8, details are provided concerning an example method according to one embodiment. In the discussion, reference is made to an example, namely, the ‘Nurse Scheduling Problem,’ or simply ‘Problem,’ which is provided for the purposes of illustration, and is not intended to limit the scope of this disclosure in any way.

It is noted that for the sake of comparison, a conventional annealing implementation of the Problem would only be able to take in single, immutable constraints, and then generate the best solution, whether or not the solution met the constraints. Any adjustments to the constraints after the solution was found would have to be made manually by the end user, and only after evaluating the end result, that is, the solution, generated by the quantum annealer.

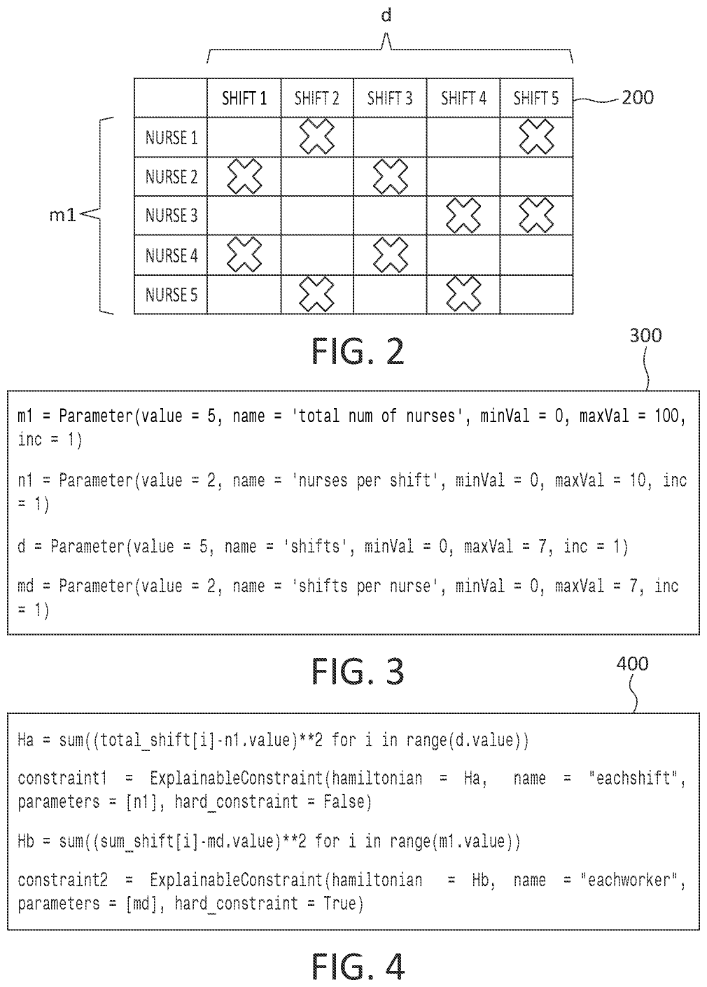

FIG. 2 discloses a schedule 200 that sketches out a solution the Problem, with m1=5, d=5, n1=2, and md=2. In more detail, the Problem involves m1 nurses being assigned to d number of shifts to produce the schedule 200. The schedule 200 is bound by two constraints namely, [1] ‘eachshift’ and [2] ‘eachworker.’ The first constraint, ‘eachshift,’ a number of n1 nurses to be working per shift, while the second constraint ‘eachworker’ obliges each nurse to work a number of md shifts per schedule. A feasible solution is one that will assign n1 nurses per shift, while also keeping every nurse occupied md shifts per week. Given the nature of the problem, it is evident that it is a hard optimization problem that can be solved by a quantum annealer and therefore, also by an explainable framework according to one embodiment. Following is a discussion of the elements of a method 150 in FIG. 1b, with reference to their operation with respect to the illustrative example of the Problem.

Turning now to FIG. 1b, an example method 150 is disclosed that involves the use of injected metadata to inform the performance of an annealing process. Examples of such metadata, and mechanisms and approaches for their association with a QUBO and its parameters and constraints were discussed earlier herein.

### C.2.1 Input Problem Constraints and Parameters

With reference as well to FIG. 1a, the example method 150 may begin when a user is prompted by the explainer to input 152 the problem constraints and parameters, such as those of the Problem, to an annealer. The problem may be a QUBO, and the constraints and parameters may be associated with the QUBO and readable by the annealer and/or an explainer. The problem constraints and parameters may also be provided, or otherwise accessible, to the explainer.

In any event, the constraints and related parameters for a problem may be provided 152 by creating a ‘Parameter’ object for every parameter and accordingly, an ‘ExplainableConstraint’ object for every constraint. When creating a parameter, the user may enter the value of the parameter, a descriptive name for the parameter, the minimum and maximum possible values the parameter is permitted to have, and the extent to which the parameter may be decremented or incremented. FIG. 3 discloses an example code snippet 300 for carrying out these processes.

It is noted that when creating an explainable constraint, a Hamiltonian for that constraint must be provided, along with the name of the constraint, the parameters it covers, and whether it is a hard or soft constraint. FIG. 4 discloses an example code snippet 400 for carrying out this process.

After the problem, constraints, and parameters, are input 152 into the annealer, the annealer may run an annealing process to determine 154 if there is a feasible solution, that is, a solution that meets the specified constraints. If no feasible solution is found, the explainer may then find 156 the most restrictive constraints and iteratively loosen 158 these constraints by expanding their restrictive parameters to obtain a nearby feasible solution as discussed below. Note that each time the constraints are loosened, the process 150 may return to 154 and the annealing process run again on the problem using the loosened constraints.

### C.2.2 Finding the Most Restrictive Constraints

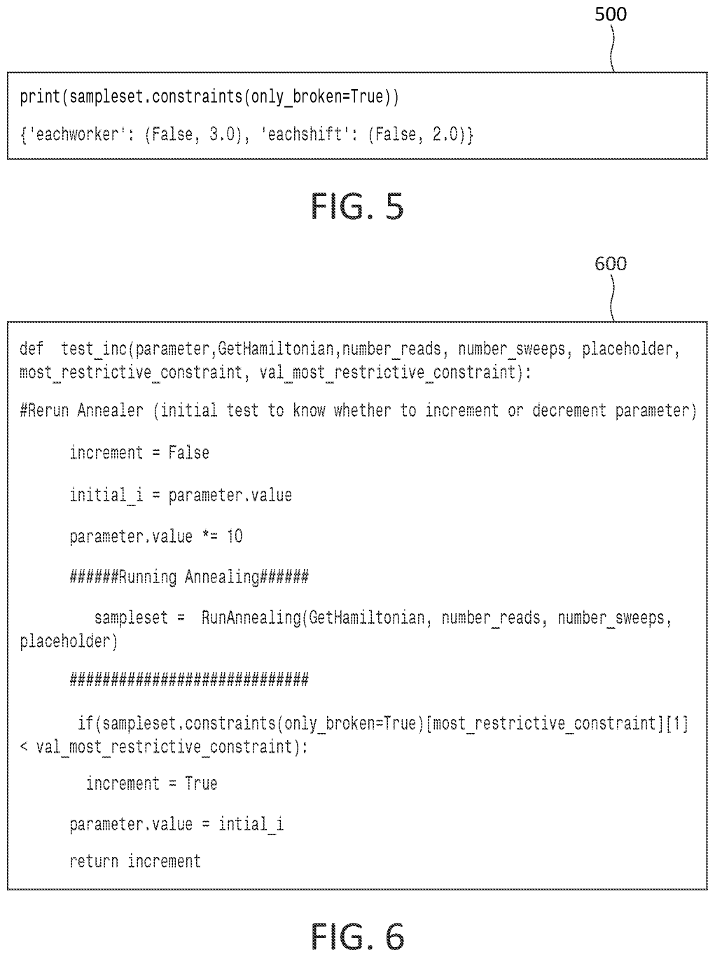

In an embodiment, the explainer may prioritize the most restrictive constraint to loosen in order to enable the annealer to reach a feasible solution. In an embodiment, such a constraint is identified as the constraint that will be broken the most to output a solution. That constraint is given a value by the annealer to indicate how broken the constraint is, with bigger values representing a relatively more broken constraint than if smaller values were used. If a constraint is not broken given the produced solution, it will not be loosened. In an embodiment, the constraint values provided by the annealer may be obtained using the code snippet 500 disclosed in FIG. 5.

It is noted that, in an embodiment of the explainer, a constraint may be ‘hard’ or ‘soft,’ which may make the constraint selection process more complicated. In more detail, a hard constraint is one that can not be sacrificed and must be satisfied, whereas a soft constraint can be broken. As a result, the explainer may prioritize all soft constraints before the hard constraints, and then, the most restrictive constraints before the less restrictive constraints. Only then can the constraints be loosened, as described below.

### C.2.3 Loosen Constraints and Expand Parameters, Iteratively

To loosen a constraint, the parameters related to the constraint must be expanded. In an embodiment, this expansion involves incrementing/decrementing the parameter x by the increment x.inc until a solution is found or until x.maxVal or x.minVal is reached. However, to determine whether the parameter should be increased or decreased, a test may be carried out on the parameter by significantly increasing the parameter, checking whether the constraint is more/less broken, and deciding, based on the outcome of that check, to either increment or decrement the parameter. The code snippet 600 in FIG. 6 may be used to apply this test.

If the explainer expands the parameters until their maximum or minimum values are reached, while still not finding a feasible solution, the annealer may prompt the user to re-enter the problem with loosened constraints and, as shown in FIG. 1b, run 154 the framework again. On the other hand, if a feasible solution is found at 154, then the annealer runs again with additional noise. In more detail, if a feasible solution is found, a check 160 may be performed to determine if that solution has been presented previously and, if not, the annealer may run again 162 using noise, as discussed below. Note that in 162, operation of both the annealer and the explainer may be implicated, that is, the explainer adds noise in the input to the annealer.

### C.2.4 Re-Run Annealing with Noise

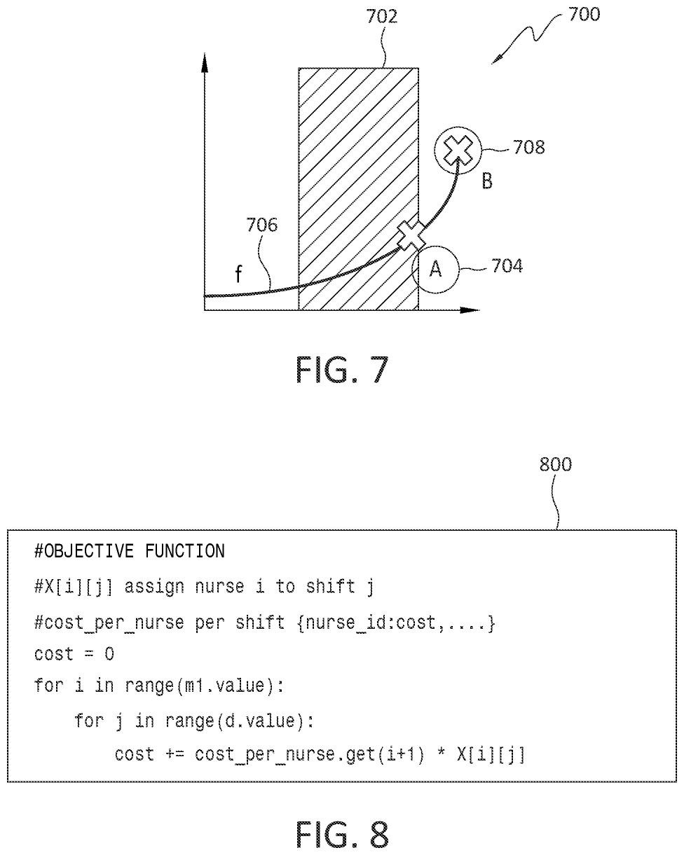

With reference now to the example graph 700 in FIG. 7, an annealer may sometimes be given an input problem with a parameter space 702. The annealer may be able, within this parameter space, to identify the best and most feasible solution A 704 to the problem, maximizing, within the parameter space 702, a value of some objective function ƒ 706. However, in this illustrative example, if the parameter space 702 is slightly increased in scope to incorporate a larger solution space, a significantly better and feasible solution B 708 can be found nearby. Consequently, once the annealer finds a feasible solution, the annealer may re-run the annealing process by expanding the parameter space 702 slightly, so as to simulate noise, thereby allowing for the exploration of existing, possibly better, solutions.

In the case of the Problem, an objective function was developed indicating that the schedule produced should not only be a feasible one but should also cost the hospital the least money. This was done by specifying different wages per nurse and accordingly causing specific nurses to be more preferable than others. The code snippet 800 disclosed in FIG. 8 may be used for the creation of this example objective function.

Returning again to the example of FIG. 1b, it was noted earlier that the annealer may re-run 162 the annealing process with noise. When a solution has been identified after this re-run 162, a check 164 may be performed to determine whether the user is satisfied with that solution. If not, the process 150 may return to the start. On the other hand, if the user is satisfied with the solution, the process 150 may complete 166.

Finally, and returning to decision point 160, if it is determined 160 that the solution has already been presented, the annealing process may be re-run 168 until a new and feasible solution, that satisfies the constraints, is found. If it is determined 170 that such a new and feasible solution has been found, the process 150 may proceed to 162. On the other hand, if no new and feasible solution has been found, the process 150 may proceed to 172 where the user is prompted by the explainer to introduce a new constraint, and re-run the explainer.

### D. Example Methods

It is noted with respect to the disclosed methods, including the example method of FIG. 1b, and FIGS. 3-8, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. Further Example Embodiments

Following are some further example embodiments of the invention. These are presented only by way of example and are not intended to limit the scope of the invention in any way.

Embodiment 1. A method, comprising: providing a problem, and associated inputs and constraints, to an annealer; when the annealer runs an annealing process on the problem and does not find a solution to the problem that meets the constraints, loosening one of the constraints; re-running the annealing process using the constraint that was loosened; performing the loosening, and the re-running, until a new and feasible solution is found that meets the constraints; and performing an optimization process that comprises re-running the annealing process, with noise, to determine whether a solution exists that is better than the new and feasible solution.

Embodiment 2. The method as recited in any preceding embodiment, wherein the problem comprises a quadratic unconstrained binary optimization (QUBO) problem.

Embodiment 3. The method as recited in any preceding embodiment, wherein the annealer is a quantum annealer.

Embodiment 4. The method as recited in any preceding embodiment, wherein the loosening of the constraints is performed by an explainer according to metadata that was provided to the annealer.

Embodiment 5. The method as recited in any preceding embodiment, wherein re-running the annealing process with noise comprises expanding a parameter space to incorporate a larger solution space.

Embodiment 6. The method as recited in any preceding embodiment, wherein the running and re-running of the annealing process is performed based on metadata provided to the annealer with the problem.

Embodiment 7. The method as recited in embodiment 6, wherein the metadata comprises strings tagged to parameters and the constraints.

Embodiment 8. The method as recited in embodiment 6, wherein the metadata enables explainability of any solutions obtained by the annealer.

Embodiment 9. The method as recited in embodiment 6, wherein the metadata is used to change the problem while the annealing process is running, and/or being re-run.

Embodiment 10. The method as recited in any preceding embodiment, wherein the loosening of the constraints is performed in real time as the annealing process is running.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

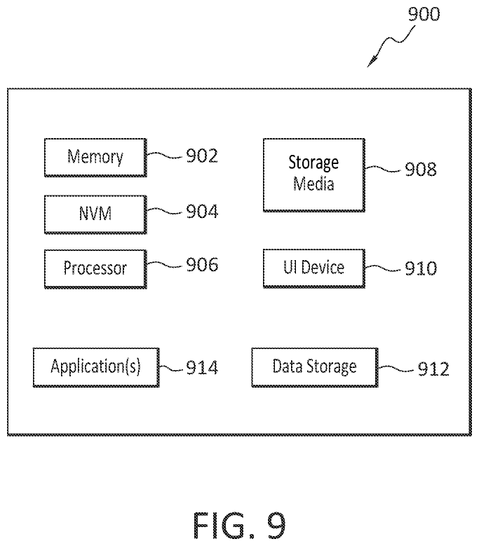

With reference briefly now to FIG. 9, any one or more of the entities disclosed, or implied, by FIGS. 1-8, and/or elsewhere herein, may take the form of, or include, or be implemented on, or hosted by, a physical computing device, one example of which is denoted at 900. Further, where any of the aforementioned elements comprise or consist of a virtual machine (VM), that VM may constitute a virtualization of any combination of the physical components disclosed in FIG. 9. As noted elsewhere herein, embodiments may additionally, or alternatively, employ quantum computing systems and components.

In the example of FIG. 9, the physical computing device 900 includes a memory 902 which may include one, some, or all, of random access memory (RAM), non-volatile memory (NVM) 904 such as NVRAM for example, read-only memory (ROM), and persistent memory, one or more hardware processors 906, non-transitory storage media 908, UI device 910, and data storage 912. One or more of the memory components 902 of the physical computing device 900 may take the form of solid state device (SSD) storage. As well, one or more applications 914 may be provided that comprise instructions executable by one or more hardware processors 906 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
providing a problem, and associated inputs and constraints, to an annealer;
when the annealer runs an annealing process on the problem and does not find a solution to the problem that meets the constraints, loosening one of the constraints;
re-running the annealing process using the constraint that was loosened;
performing the loosening, and the re-running, until a new and feasible solution is found that meets the constraints; and
performing an optimization process that comprises re-running the annealing process, with noise, to determine whether a solution exists that is better than the new and feasible solution.

2. The method as recited in claim 1, wherein the problem comprises a quadratic unconstrained binary optimization (QUBO) problem.

3. The method as recited in claim 1, wherein the annealer is a quantum annealer.

4. The method as recited in claim 1, wherein the loosening of the constraints is performed by an explainer according to metadata that was provided to the annealer.

5. The method as recited in claim 1, wherein re-running the annealing process with noise comprises expanding a parameter space to incorporate a larger solution space.

6. The method as recited in claim 1, wherein the running and re-running of the annealing process is performed based on metadata provided to the annealer with the problem.

7. The method as recited in claim 6, wherein the metadata comprises strings tagged to parameters and the constraints.

8. The method as recited in claim 6, wherein the metadata enables explainability of any solutions obtained by the annealer.

9. The method as recited in claim 6, wherein the metadata is used to change the problem while the annealing process is running, and/or being re-run.

10. The method as recited in claim 1, wherein the loosening of the constraints is performed in real time as the annealing process is running.

11. A non-transitory storage medium having stored therein instructions that are executable by one or more hardware processors to perform operations comprising:
providing a problem, and associated inputs and constraints, to an annealer;
when the annealer runs an annealing process on the problem and does not find a solution to the problem that meets the constraints, loosening one of the constraints;
re-running the annealing process using the constraint that was loosened;
performing the loosening, and the re-running, until a new and feasible solution is found that meets the constraints; and
performing an optimization process that comprises re-running the annealing process, with noise, to determine whether a solution exists that is better than the new and feasible solution.

12. The non-transitory storage medium as recited in claim 11, wherein the problem comprises a quadratic unconstrained binary optimization (QUBO) problem.

13. The non-transitory storage medium as recited in claim 11, wherein the annealer is a quantum annealer.

14. The non-transitory storage medium as recited in claim 11, wherein the loosening of the constraints is performed by an explainer according to metadata that was provided to the annealer.

15. The non-transitory storage medium as recited in claim 11, wherein re-running the annealing process with noise comprises expanding a parameter space to incorporate a larger solution space.

16. The non-transitory storage medium as recited in claim 11, wherein the running and re-running of the annealing process is performed based on metadata provided to the annealer with the problem.

17. The non-transitory storage medium as recited in claim 16, wherein the metadata comprises strings tagged to parameters and the constraints.

18. The non-transitory storage medium as recited in claim 16, wherein the metadata enables explainability of any solutions obtained by the annealer.

19. The non-transitory storage medium as recited in claim 16, wherein the metadata is used to change the problem while the annealing process is running, and/or being re-run.

20. The non-transitory storage medium as recited in claim 11, wherein the loosening of the constraints is performed in real time as the annealing process is running.
